(19) United States
(12) Patent Application Publication
(10) Pub. No.: US 2006/0099322 A1
(43) Pub. Date: May 11, 2006

(54) Animal food additive and animal food containing said additive

(76) Inventors: Steffen Schule, BUHLERZELL (DE); Thomas Backers, Rosenberg (DE)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/527,589

(22) PCT Filed: Sep. 17, 2003
(86) PCT No.: PCT/EP03/10320

§ 371 Date: Sep. 22, 2005

(30) Foreign Application Priority Data
Sep. 18, 2002 (DE) 102 43 410.7

(51) Int. Cl. A23K 1/00

(52) U.S. Cl. 426/635

(57) ABSTRACT

The invention relates to an animal food additive for working animals which are bred and exist in a state of gravidity, consisting of a proportion of raw fibers. In order to obtain quick satiation in pregnant working animals using feeding systems such as satiate feeding, the animal food additive contains, according to the invention, a raw fiber concentrate of fibrillated lignocellulose.

### TECHNICAL FIELD

The invention is based on problems which arise with the feeding of pregnant sows.

The rearing of pregnant sows takes place today, for the most part, in no-bedding systems with individual animal rearing, because of labor and other costs. As a result of new ordinances, rearing methods and feeding systems which are more suitable to the species will be established in the future. The rearing of groups of pregnant sows will involve numerous challenges for feeding technology.

During pregnancy, the animal's energy intake must be limited, so as to avoid an excessively large weight (fat) gain. In the past, this was ensured by high-fiber and low-energy roughage and fresh green roughage such as grass, turnips, hay and so forth. The use of these animal foods, however, is hardly practicable anymore, under economic conditions, because of the present-day rearing system and the automated feeding systems. Therefore, at present, the energy intake of the animal is, for the most part, limited via a rationed animal food model. Most of the pregnant sows are therefore kept in box stands with rationed feeding. This rearing system is not particularly suitable for the species and results in behavior anomalies in the animals.

### BACKGROUND OF THE INVENTION

In rearing of the pregnant sows in box stands with rationed feeding, satisfying the animals is not so important. However, it is expected that in the future, above all, feeding to satisfaction and feeding on request will become established as feeding systems in actual practice. Already today, new constructions of sow rearing systems are being correspondingly designed, without the feeding-technical problems—above all, the selection of a suitable crude fiber carrier—being solved.

In view of this background, an EU guideline (EU Guidefine 91/630 EEC regarding the Minimum Requirements for the Protection of Swine) for the rearing of swine was passed in the year 2000, which must be implemented by 2006. According to this Guideline, sows must constantly have access to activity material in the future, and the animals must be able to move freely in a stall area. Constant access to animal food—namely, “feeding to satisfaction” or “ad-libitum feeding”—is considered, above all, “activity material.” In feeding to satisfaction, the animals are presented with the feed ad libitum in automatic feeding units. Here, the goal must be to limit the weight increase of the sow via the energy content of the ingested feed ration. As with all feeding systems, the goal is namely that the pregnant animal in no way becomes fat.

However, in order to prevent the undesired weight (fat) gain of the animals (and the related, poorer birth performance) with self-determined feed intake, the energy concentration in the ration removed by the animal must be lowered. This is, at present, attained with higher administrations of rough fibers, which should introduce as little energy as possible into the feed.

### THE INVENTION

The invention is based on the problem of bringing about a quick satisfaction, without negative side effects, with economically useful pregnant animals and the use of feeding systems, such as feeding to satisfaction.

This problem is solved by the animal food additive given in Claim 1 or the animal food given in Claims 6 or 7 containing the animal food additive.

The effect of the invention is based on the highland rapid swelling capacity of fibrillated lignocellulose. Food intake can be influenced via the swelling—that is, via the water intake capacity of the feed components and their swelling rate. The animal food is absorbed; swells already in the stomach; and provides a feeling of satisfaction in the animals, wherein the nutrient intake remains within limits despite the free access, and the animal will not become too fat.

In order to be particularly suitable for the invention, it is recommendable, according to Claim 2, that the crude fiber concentration have a water retention capacity of above 700%—that is, can retain a water quantity of 700% of its own weight.

A material which can be taken into consideration as a crude fiber concentrate with this characteristic is the product “ARBOCEL” (registered trademark of the Rettenmaier & Söhne GmbH+Co. KG) of the Rettenmaier & Söhne GmbH+Co. KG.

ARBOCEL lignocellulose has, by far, the highest water intake capacity (about 500-800%), compared with other crude fiber carriers found on the market (for example, wheat bran, about 200%; sugar beet scraps, about 400%).

Another important characteristic of the animal food additive, in accordance with the invention, is the high swelling rate according to Claim 3. The swelling, in any case, has to be completed to a substantial degree while the animal food is still in the stomach, because only then does the satisfied feeling caused by the swelling take effect. As a rule, the swelling is already concluded after about one minute.

The high crude fiber content of the animal food additive permits, according to Claim 4, the attaining of the crude fiber content in the animal food needed to reach the desired effect by the addition of relatively small quantities of the animal food additive.

If the animal food additive is compacted, according to Claim 5, its handling is made easier. There is no dust during the addition, and the uniform mixing into the animal food is made easier. Compacting in this connection should mean a compression of fine-particle materials to form cohesive larger aggregates—for example, a compression in a roll gap to form a flat structure, which is subsequently broken into small pieces.

The invention is also realized in the animal food provided with the animal food additive according to Claim 6 or Claim 7.

The fractions of the animal food additive in the total weight of the animal food, according to Claim 8, can be 0.5-8.0%. Mostly, however, quantities in the range of 1.0-3.0 wt % are sufficient.

It may be advantageous also to pellet the animal food provided with the animal food additive (Claim 9).

An important factor with animal foods of the type being discussed is the content of undesired substances in the crude fiber carriers: Traditional crude fiber carriers, such as wheat bran, straw meals, green meals, and so forth, frequently contain undesired substances, such as mycotoxins, and high microbial burdens. Moreover, higher contents of fermentable, soluble fibrous substances are contained in traditional crude fiber carriers.

The lignocellulose to be used in accordance with the invention is, on the other hand, free of mycotoxins, has a very low microbial burden, and mostly contains insoluble crude fibers. Soluble fibrous substances bind nutrients and reduce their availability. This involves two disadvantages, in turn. The availability, above all, of the microingredient (mineral substances, trace elements, vitamins) is hard to calculate reliably, and the needed, higher addition of these substances is, on top of that, rather expensive.

The advantage of insoluble fibrous substances, in comparison to soluble ones, is to be found here, above all, in the long-lasting satisfaction feeling, because no fractions of the crude fibers are dissolved out and the fibers are retained in their effect. Also, no nutrients, such as mineral substances, are bound.

Furthermore, soluble fibrous substances are strongly fermented in the digestive tract and thus lead to other problems such as the formation of gas and negatively influenced excrement consistency.

In addition, traditional crude fiber carriers (here, above all, sugar beet scraps) contain very disadvantageous proportions of calcium and magnesium, which strongly reduces the animal productions of the sows. The lignocellulose to be used in accordance with the invention does not influence the Ca—Mg equilibrium.

The excrement consistency is a very important parameter both in the rearing of breeding sows and with fattened pigs and other useful animals (calves). As a result of the high swelling capacity, the fibrillated lignocellulose is able to bind excess, unbound or non-thickened liquid in the intestine and thus to buffer diarrhea. On the other hand, the lignocellulose contains, almost exclusively, insoluble components. There is no gel formation, and the typical slimy excrement, as is observed, for example, with higher dosages of sugar beet scraps, is reliably prevented.

The excrement consistency is also essential with regard to the hygiene in the stall. If, as a result of high contents of fermentable, soluble fibers, there is the typical slimy excrement (above all, with beet scraps), then the excrement does not pass readily through the slotted floors of the stalls, but rather accumulates on their surface. This involves considerable risks for two reasons. On the one hand, the sows or fattened pigs can slip on the slippery floors and break a bone on the other hand, in the compartments after the birth of the piglets, this leads to considerable coliform burdens with the piglets, since the young piglets ingest excrement when playing.

Furthermore, it is of elementary importance that constipation (blockage) be avoided before the birth of the piglets. The intestine of the sow should be naturally emptied before the birth of the piglets, so as to make possible a quicker and simpler birth. By the addition of fibrillated lignocellulose as insoluble crude fiber, an acceleration of the intestinal transit time and a related better intestinal emptying are attained.

The high water intake capacity of the lignocellulose to be used in accordance with the invention is brought about by the fibrillation—that is, by the special production method of this lignocellulose, in particular, with the product ARBOCEL. Here, the material is processed by a mill-like device, so that the individual fibers are largely dissolved or separated from one another and a particularly loose, capillary-intensive, absorbable structure is formed.

The animal very quickly attains a long-lasting satisfied feeling due to the strong swelling of the animal food in the stomach and then ceases further food intake as a result of this satisfied feeling. In this way, excess food consumption in feeding to satisfaction is greatly limited and feed costs are cut down. This effect occurs also with species other than pigs. The invention is therefore not limited to pigs, although it started with them.

The already mentioned absence of mycotoxins in the fibrillated lignocellulose is a decisive advantage, especially in the feeding of mother pigs. It is known that great risks are found with regard to mycotoxins in many traditional crude fiber carriers, such as straw meals, brans, and so forth. Above all, fusarium toxins (zeralenone, DON [deoxynivalenol]) represent great danger for the fertility event and the litter output of pigs.

With feeding to satisfaction of pregnant mother pigs, it is also necessary that the energy content in the animal food be reduced to 8.0-8.5 MJME (megajoule metabolizable energy) per kg animal food. This reduction of the energy content with a simultaneous sufficient provisioning with proteins and mineral substances can be accomplished only with great difficulty with traditional crude fiber carriers, since they always introduce certain energy concentrations into the animal food. With traditional crude fiber products, therefore, a very high concentration is needed, so as to correspondingly reduce the energy content of the ration. These high contents of not very tasty products in the ration lead to a selection of food components by the animals—that is, it may be that the crude fiber carriers are not eaten in sufficient quantity at all.

Due to the very high crude fiber content of the lignocellulose to be used in accordance with the invention (for example, 65% according to the Weender analysis), this is most suitable, as an animal food additive, in the sense of the invention, since practically no energy is introduced into the food by it. Thus, it is already possible to appreciably increase the crude fiber content of the animal food with relatively low usage quantities and thus to clearly reduce the energy concentration in the animal food.

The fibrillated lignocellulose to be used in accordance with the invention is suitable, however, not only for the feeding to satisfaction of pregnant pigs, but rather also for the rationed feeding of sows. With the rationed feeding, about 6% crude fiber are desired in the total ration. Cereal-accentuated rations (barley), as they are usually used, contain about 4% crude fibers. By the use of ca. 3% fibrillated lignocellulose, these rations are upgraded to about 6% per fiber. About 15-20% usage quantity are needed from the traditional crude fiber carriers (bran, sugar beet scraps, green meals, hay meals, soybean shells, and so forth), in order to upgrade rations to the desired 6% crude fibers. The fibrillated lignocellulose makes it possible, therefore, to already increase the crude fiber content in animal food rations with low usage quantities.

Due to the availability of the fibrillated lignocellulose in constant quality the entire year, there are neither hygienic, microbiological, nor logistical problems, as is the case with the other crude fiber carriers which are available conditional to the harvest. Moreover, they must also be preserved and stored.

Another positive aspect for the use of fibrillated lignocellulose is the possibility of treating non-infectiously-induced diarrheic illnesses with most species (mainly calves, pigs). Here, a stabilization of the water economy in the intestine and an improvement of the excrement consistency is attained in physical ways by the very high water-binding capacity.

Practical experience shows that in feeding experiments with the addition of only 1.2% fibrillated lignocellulose, an entire 15% of mycotoxin-containing wheat bran can be replaced. For compensation of the freed quantity in the recipe, barley from one's own farm can be added. Thus, the formulation in the crude fiber content remained essentially constant, and it was possible to attain a slight cost reduction.

A higher water intake was also observed With pregnant sows due to the addition of ARBOCEL lignocellulose. The sows are better flushed in this way; the urine-pH value is positively influenced; and in actual practice, significantly less MMA (mastitis, metritis, agalactia, inflammation of the udder and uterus, which leads to milk deficiency) is observed.

The swelling and the fiber's own capillary effect of the lignocellulose are purely physical effects, which do not presuppose any digestive processes specific to a species. Thus, the described way of acting of the lignocellulose (treatment and prevention of diarrhea illnesses, influencing the excrement consistency, satisfaction effect, and so forth) can be transferred to other species and even to human nutrition.

In order to test this, feeding experiments with fur-bearing animals were carried out. Foxes and minks were fed, in corresponding farms, with pasty feeds which, for the most part, consist of slaughter by-products and are very high-energy, as a rule. Since the parent animals ingest a large amount of energy during the intensive feeding, they tend to become fat. Since this leads to poor birth outputs, very low-energy food must be administered in the fall. Likewise, energy must be controlled during lactation. To this end, 2% ARBOCEL is mixed into the food of the fur-bearing animals. In this way, it was possible to observe a better satisfaction of the animals and a higher water intake—that is, the same results as in the area of feeding of breeding sows.

Finally, feeding experiments were also carried out with fattened pigs. In later feeding stages, they also tend to get fat, which has negative effects on the muscular substance portion and thus on the economic success of the fattening. With only 1% ARBOCEL, it was possible to attain, here, the desired reduction of the energy intake during the feeding.

All preceding % indications are weight percent.

1. Animal food additive for economically useful animals which are pregnant, lactating, being fattened or raised, with a fraction of fibrillated, cellulose-containing fibers, wherein the additive comprises a crude fiber concentrate of fibrillated lignocellulose.

2. Animal food additive according to claim 1, wherein the crude fiber concentrate has a crude fiber content (according to the Weender analysis) of over 60%, a water retention capacity of 500-800%, and such a high swelling capacity that the swelling is carried out to a substantial extent while the food, which does not contain the animal food additive, is still found in the stomach.

3. Animal food additive according to claim 1, wherein the additive is compacted.

4. Animal food for economically useful animals which are pregnant, lactating, being fattened or raised, with an additive of fibrillated, cellulose-containing fibers, wherein the food comprises an animal food additive according to claim 1.

5. Animal food according to claim 4, wherein the additive is present in a quantity of 0.5-8.0% of the food.

6. Animal food according to claim 4, wherein the food is pelleted.

7. Animal food additive according to claim 2, wherein the additive is compacted.

8. Animal food for economically useful animals which are pregnant, lactating, being fattened or raised, with an additive of fibrillated, cellulose-containing fibers, wherein the food comprises an animal food additive according to claim 2.

9. Animal food for economically useful animals which are pregnant, lactating, being fattened or raised, with an additive of fibrillated, cellulose-containing fibers, wherein the food comprises an animal food additive according to claim 3.

10. Animal food according to claim 5, wherein the food is pelleted.
